(19) United States
(12) Patent Application Publication
(10) Pub. No.: US 2025/0234130 A1
(43) Pub. Date: Jul. 17, 2025

(54) Multimicrophone Acoustic Feedback Cancellation Through Informed Adaptive Beamforming

(71) Applicant: META PLATFORMS TECHNOLOGIES, LLC, Menlo Park, CA (US)

(72) Inventors: Francesco Nesta, Aliso Viejo, CA (US); Kashyap Patel, Fuquay Varina, NC (US); Jung-Suk Lee, Sammamish, WA (US); Ali Aroudi, Redmond, WA (US)

(21) Appl. No.: 19/010,771

(22) Filed: Jan. 6, 2025

Related U.S. Application Data
(60) Provisional application No. 63/620,684, filed on Jan. 12, 2024.

(51) Int. Cl. H04R 3/00; H04R 3/02

(52) U.S. Cl. CPC H04R 3/005; H04R 3/02; H04R 2203/12

(57) ABSTRACT

Methods and systems are described for acoustic feedback cancellation through informed beamforming associated with a device. In various examples, systems or methods receive audio signals from a microphone and determine a transfer function between a speaker and the microphone. A feedback covariance may be generated using the determined transfer functions, followed by generation of a total noise variance based on combining the feedback covariance with a noise covariance. Beamforming may then be performed based on the total noise variance to spatially filter and suppress audio signals from feedback paths while preserving signals from target directions. The system may adapt to changing acoustic conditions by updating the feedback covariance matrix and adjusting the beamforming accordingly.

### CROSS-REFERENCE TO RELATED APPLICATIONS

This application claims priority to U.S. Provisional Application No. 63/620,684, filed Jan. 12, 2024, entitled “Multimicrophone Acoustic Feedback Cancellation Through Informed Adaptive Beamforming,” which is incorporated by reference herein in its entirety.

### TECHNOLOGICAL FIELD

Examples of the present disclosure relate generally to methods, apparatuses, or computer program products for an audio device, specifically audio signaling pathways.

### BACKGROUND

Electronic devices are constantly changing and evolving to provide a user with flexibility and adaptability. With increasing adaptability in electronic devices users are taking and keeping their devices on their person during daily activities. In many instances, it may be imperative for a user to be able to hear what is being conveyed on their electronic device. As such, devices may have methods or systems in place to aid in the user's ability to hear, such as conversation focus or hearing enhancement to enable communication in noisy environments for users, whether the user may be hearing impaired or not. Conventionally, these hearing features may combine a number of microphones configured to produce an enhanced signal where the target speaker is enhanced while the noise is attenuated. In such conventional systems, the audio signal may be presented in real-time to the user through an audio playback subsystem which amplifies the audio signal so that it is audible to the user. However, due to the proximity between microphone and loudspeaker in size-constrained form factors, such as hearing aids, smart glasses, headphones, or other wearable(s) (e.g., wearable devices), conversation focus, or hearing enhancement may be sensitive to acoustic feedback problems.

### BRIEF SUMMARY

Methods, apparatuses, or systems are described for acoustic feedback cancellation through informed beamforming. In an example, a system may receive, via a device associated with a user, an audio signal associated with one or more microphones, wherein the audio signal may include acoustic feedback and an input audio. The audio signal may be converted to audio data and transferred or transmitted to one or more multichannel neural networks and a beamformer (BF). One or more transfer functions may be estimated, via each of the one or more multichannel neural networks, associated with the received audio signal. The one or more estimated transfer functions may be associated with the audio signal, wherein the one or more estimated transfer functions may define acoustic feedback associated with the received audio signal. The one or more transfer functions may be combined (e.g., a multichannel feedback covariance) and added to a multichannel noise covariance to create a total noise covariance (e.g., a multichannel total noise covariance). A BF may receive the total noise covariance, the steering direction, and the audio data to filter and determine a target audio associated with such direction. The audio data may be filtered to the target audio based on one or more transfer functions received via total noise covariance. The target audio may be outputted to feedforwarding processes where the target audio may undergo any processes suitable to the audio device to allow for a user to hear the audio associated with the target audio.

In one example of the present disclosure, a method is provided. The method may include receiving audio signals. The method may further include determining, based on the audio signals, a transfer function between a speaker and a microphone. The method may further include generating a feedback covariance using the transfer function. The method may further include generating a total noise variance based on a combination of the feedback covariance and a noise covariance. The method may further include beamforming based on the total noise variance.

In another example of the present disclosure, a device is provided. The device may include one or more processors and a memory including computer program code instructions. The memory and computer program code instructions are configured to, with at least one of the processors, cause the device to at least perform operations including receiving audio signals. The memory and computer program code are also configured to, with the processor(s), cause the device to determine, based on the audio signals, a transfer function between a speaker and a microphone. The memory and computer program code are also configured to, with the processor(s), cause the device to generate a feedback covariance using the transfer function. The memory and computer program code are also configured to, with the processor(s), cause the device to generate a total noise variance based on a combination of the feedback covariance and a noise covariance. The memory and computer program code are also configured to, with the processor(s), cause the device to beamform based on the total noise variance.

In yet another example aspect of the present disclosure, a computer program product is provided. The computer program product may include at least one non-transitory computer-readable medium including computer-executable program code instructions stored therein. The computer-executable program code instructions may include program code instructions configured to receive audio signals. The computer program product may further include program code instructions configured to determine, based on the audio signals, a transfer function between a speaker and a microphone. The computer program product may further include program code instructions configured to generate a feedback covariance using the transfer function. The computer program product may further include program code instructions configured to generate a total noise variance based on a combination of the feedback covariance and a noise covariance. The computer program product may further include program code instructions configured to beamform based on the total noise variance.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates a block diagram of an example data pipeline associated with acoustic feedback mitigation.

FIG. 2A illustrates an example transfer function.

FIG. 2B illustrates an example transfer function.

FIG. 3 illustrates an example block diagram of acoustic feedback cancellation mitigation.

FIG. 4 illustrates a block diagram of an example data pipeline associated with an adaptive feedback mitigation (AFM).

FIG. 5 illustrates an example block diagram of an adaptive feedback mitigation (AFM), in accordance with an example of the present disclosure.

FIG. 6 illustrates an example method of adaptive feedback mitigation.

FIG. 7 illustrates an example method of adaptive feedback mitigation.

FIG. 8 illustrates an example processing system, in accordance with an example of the present disclosure.

FIG. 9 illustrates an example head mounted device (HMD).

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein. Like reference numerals refer to like elements throughout.

As used herein, the terms “data,” “content,” “information” and similar terms may be used interchangeably to refer to data capable of being transmitted, received and/or stored in accordance with embodiments of the disclosure. Moreover, the term “exemplary,” as used herein, is not provided to convey any qualitative assessment, but instead merely to convey an illustration of an example. Thus, use of any such terms should not be taken to limit the spirit and scope of embodiments of the disclosure.

As defined herein a “computer-readable storage medium,” which refers to a non-transitory, physical, or tangible storage medium (e.g., volatile, or non-volatile memory device), may be differentiated from a “computer-readable transmission medium,” which refers to an electromagnetic signal.

As referred to herein, “artificial reality” may refer to a form of immersive reality that has been adjusted in some manner before presentation to a user, which may include, for example, a virtual reality, an augmented reality, a mixed reality, a hybrid reality, Metaverse reality or some combination or derivative thereof. Artificial reality content may include completely computer-generated content or computer-generated content combined with captured (e.g., real-world) content. In some instances, artificial reality may be associated with applications, products, accessories, services, or some combination thereof, that may be used to, for example, create content in an artificial reality or are otherwise used in (e.g., to perform activities in) an artificial reality.

As referred to herein, “artificial reality content” may refer to content such as video, audio, haptic feedback, or some combination thereof, any of which may be presented in a single channel or in multiple channels (such as stereo video that produces a three-dimensional (3D) effect to the viewer) to a user.

As referred to herein, a Metaverse may denote an immersive virtual/augmented reality world in which augmented reality (AR) devices may be utilized in a network (e.g., a Metaverse network) in which there may, but need not, be one or more social connections among users in the network. The Metaverse network may be associated with three-dimensional (3D) virtual worlds, online games (e.g., video games), one or more content items such as, for example, non-fungible tokens (NFTs) and in which the content items may, for example, be purchased with digital currencies (e.g., cryptocurrencies) and other suitable currencies.

It is to be understood that the methods and systems described herein are not limited to specific methods, specific components, or to particular implementations. It is also to be understood that the terminology used herein is for the purpose of describing particular embodiments only and is not intended to be limiting.

Acoustic feedback has been shown to be a problem in which the positive loop gain that is utilized to enhance the audio signal may lead to the response of the loop to diverge, which may lead to acoustic feedback being received. An approach to mitigate acoustic feedback is to use adaptive feedback cancellation. However, due to conventional acoustic and application limitations, the accuracy of acoustic feedback cancellation may be insufficient which may introduce audio signal distortion.

The adaptive feedback mitigation (AFM) system, as disclosed, may increase the estimation accuracy of acoustic feedback associated with an audio device which may be utilized to allow a user to hear or receive audio signals. The adaptive feedback mitigation pathway as disclosed may utilize multichannel spatial filters aided by the acoustic feedback canceller, rather than canceling the acoustic feedback signal in each channel independently. The AFM system of the present disclosure may be configured to estimate transfer functions between one or more speakers (e.g., loudspeakers, or the like) and one or more microphones. Speaker as referred to herein may refer to a loudspeaker. The estimated transfer functions may be used to build a multichannel covariance matrix, which may be combined with a multichannel noise covariance matrix. The combined covariance may then be utilized to adaptively design a beamformer (BF) steered in a specific direction associated with a wanted portion of a received audio signal. The acoustic feedback may be solely canceled or suppressed through the multichannel BF filtering, thus removing signal distortion caused by local acoustic feedback canceller (e.g., transfer function estimation module/component) instabilities, such as but not limiting to distortions caused by vibrations, output of the speaker, or the like.

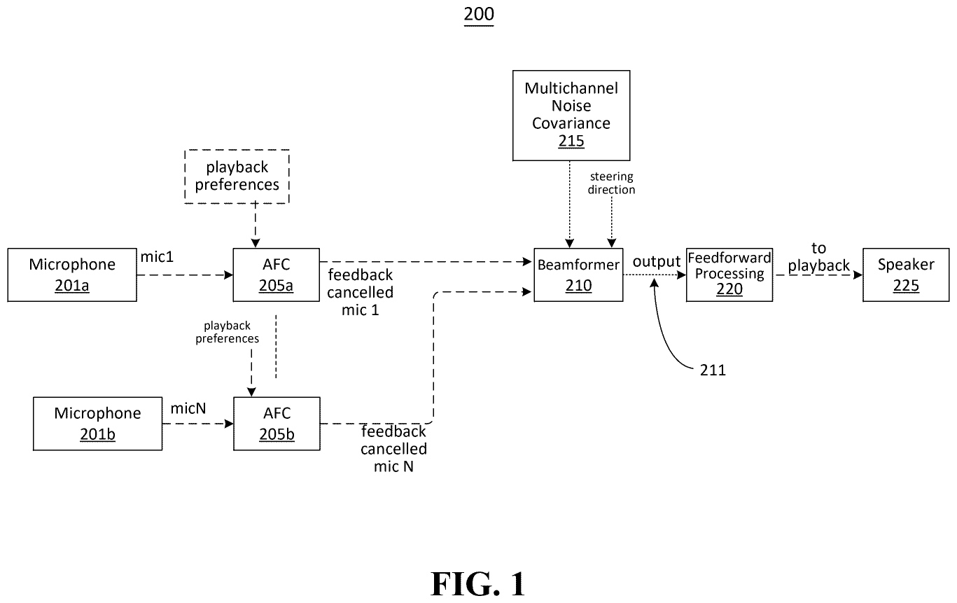

Now referring to FIG. 1, an example data pipeline 200 associated with an acoustic feedback mitigation process. It is contemplated herein that the processes of data pipeline 200 may occur on a chip or processor designed to support audio pathways in a device, such that audio signals may be decoded, amplified, or the like. Data pipeline 200 may include one or more microphones (e.g., microphone 201a, microphone 201b), one or more acoustic feedback cancellers (e.g., acoustic feedback canceller 205a, acoustic feedback canceller 205b), a beamformer (BF) 210, a multichannel noise covariance block 215, or feedforward processing block 220. Feedback cancellation may be a method utilized for canceling audio feedback in a variety of audio devices, such as but not limited to digital hearing aids. Audio feedback may be defined as a positive feedback situation that may occur associated with an audio path between an audio input (e.g., one or more microphones) and an audio output (e.g., one or more speakers). The positive feedback may refer to a process in a feedback loop which may exacerbate the effects of small, captured audio signals, for example, a small audio signal may be increased in magnitude in an audio system where positive feedback occurs. For example, an audio signal received by a microphone is amplified and passed out of a speaker, the sound from the speaker may then be received by the microphone again, thus amplifying the audio signal associated with the sound from the speaker further, and then passed out through the loudspeaker again. The action of the sound from the speaker being captured again through the microphone may result in a distortion (e.g., howl) of the output associated with the speaker. The resultant distortion may be an unwanted sound at which acoustic feedback cancellers may be configured to mitigate.

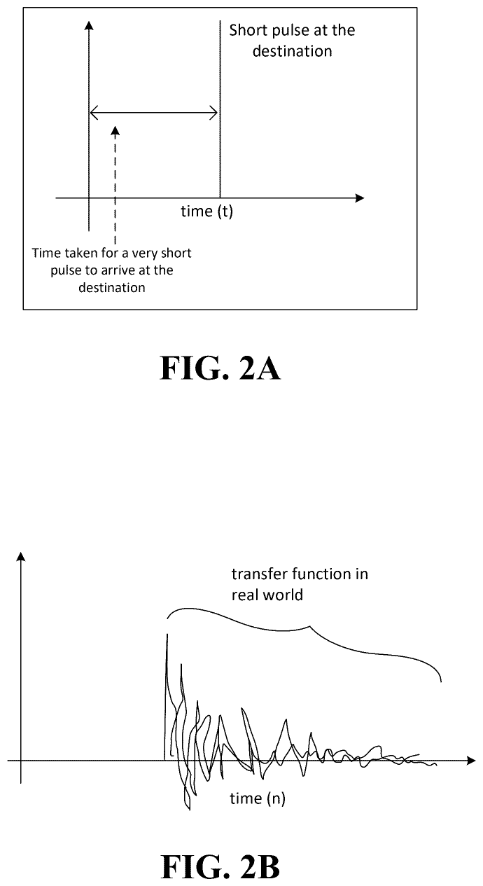

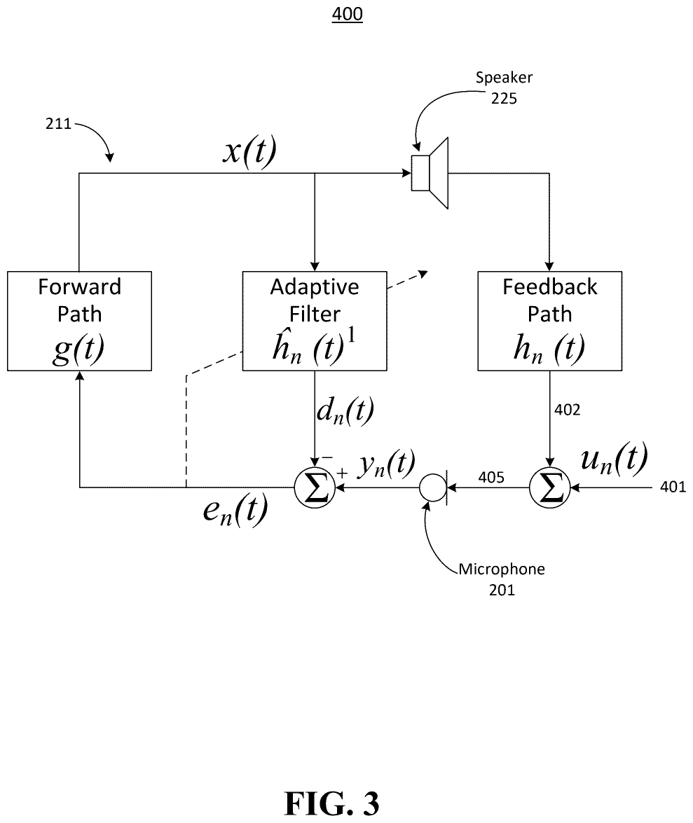

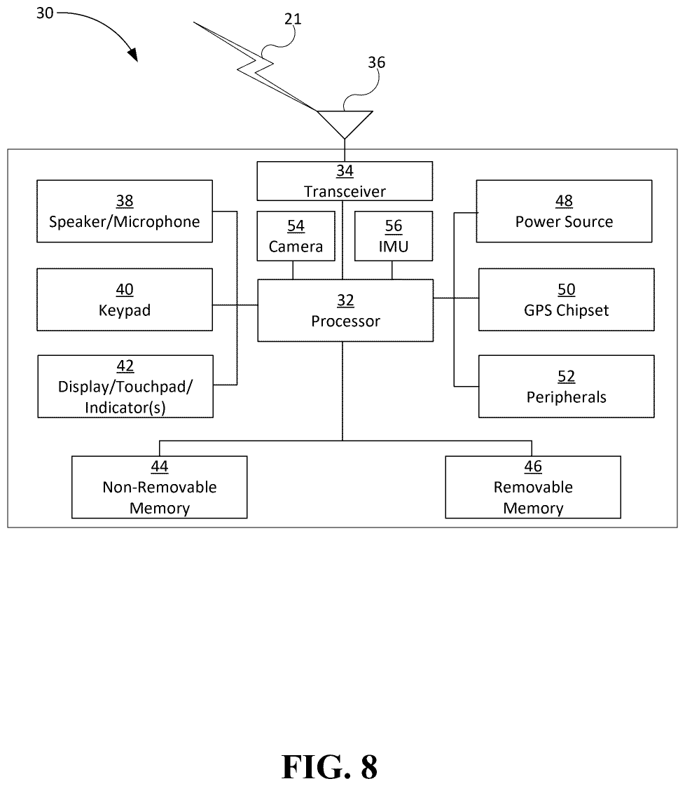

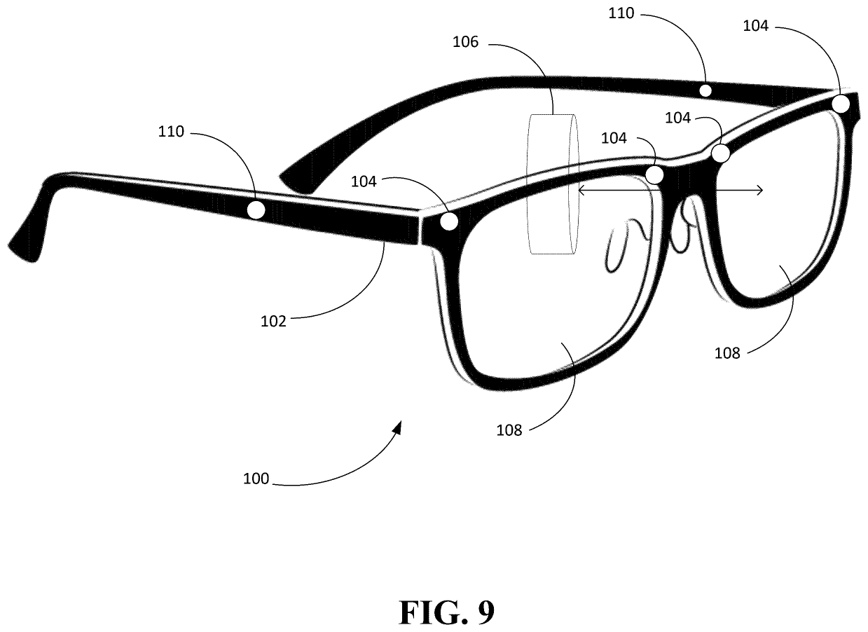

One or more microphones (e.g., microphone 201a, microphone 201b) may convert a sound to an audio signal, wherein the audio signal may be transmitted to an acoustic feedback canceller (e.g., acoustic feedback canceller 205a, acoustic feedback canceller 205b) associated with each of one or more microphones (e.g., microphone 201a, microphone 201b), for example acoustic feedback canceller 205a may be associated with microphone 201a. It is contemplated that there may be any number of arrangements between a microphone and an acoustic feedback canceller, wherein there may be ‘N’ microphones and ‘N’ acoustic feedback cancellers, at which an audio signal may be transmitted. Audio signal data transmitted to acoustic feedback canceller 205a,205b may undergo a series of estimations and processes which may be further defined in FIG. 3. The acoustic feedback canceller 205a may estimate a transfer function, wherein the transfer function may be a representation of a comparison of two audio signals (e.g., microphone audio signal and speaker audio signal) to verify proper gain, phase, or frequency response through a device (e.g., smart glasses 100 of FIG. 9 or UE 30 of FIG. 8). The transfer function may be a representation in the form of an audio signal of an acoustic pathway that the sound of a pulse physically goes through to arrive at the destination (e.g., a microphone 201a) from a certain source location (e.g., a speaker 225). In some systems, the transfer function is estimated to be linear which may be illustrated in FIG. 2A. It is contemplated that the transfer function may be illustrated by any form of a linear graph as a function of time based on the received audio signal. In very short pulses of sound or audio signal transfer functions may be estimated to be horizontal, as shown in FIG. 2A. The transfer function estimation may be based on an ideal scenario, where there are no obstacles along the acoustic pathway to the output (e.g., speaker 225). However, in some examples, there may be obstacles presented to an audio signal before the audio signal reaches the destination (e.g., microphone 201a), such as but not limited to vibration, walls of a room, other users, a user's head/hand, formfactor of a user device, or the like. In some examples the transfer function may appear more like the graph of FIG. 2B, in which there may be significant acoustic feedback to distort the output audio in conventional acoustic feedback mitigation systems due to the estimation of a linear transfer function.

The result of the acoustic feedback canceller 205a, 205b processes may be one or more audio signals associated with each of the one or more microphones 201a,201b. Each of the audio signals have less noise (e.g., some degree of potential acoustic feedback canceled). The resultant audio signals may then be received by BF 210, in which the combination of each of the received audio signals may be processed. BF 210 may be configured to determine from the received audio signals, which audio signal is the desired or targeted audio, and in response BF 210 may enhance the audio signals associated with a microphone 201a or a direction. As such, the other received audio signals may be determined to be noise. In some examples, BF 210 may be configured to determine a target audio 211 based on the received audio signals from one or more acoustic feedback canceller 205a,b. In some examples, BF 210 may also reduce noise in the audio signal based on the determination of the target audio 211. BF 210 may also receive multichannel noise covariance (e.g., multichannel noise covariance block 215). The multichannel noise covariance of block 215 may be a measure of the spatial correlation between channels. The multichannel may refer to one or more audio signals associated with one or more microphones.

The target audio 211 may then undergo feedforward processing 220. Feedforward processing 220 may be any audio pathway that leads to the playing of sound, via speaker 225, to a user, such as but not limited to amplifying, decoding, or any other suitable process. It is contemplated that there may be one or more speakers associated with data pipeline 200.

FIG. 3 depicts a block diagram of an audio feedback cancellation system 400. Audio feedback cancellation system 400 may illustrate an arrangement of a speaker 225 and a microphone 201. The input 405 (e.g., total audio signal) received via microphone 201 may comprise two audio signal components, in which a first component may be the incoming audio signal (e.g., inputs), wherein first component may be an incoming audio signal 401 (uₙ(t)). A second component may be acoustic feedback 402 (hₙ(t)), due to the coupling between the speaker 225 and the microphone 201 audio signals, wherein t may be a function of time. The acoustic feedback 402 may be first estimated by using an adaptive filter (hₙ(t)). The adaptive filter may include an estimated transfer function. The estimated feedback path may be used to compute the estimated feedback contribution (dₙ(t)) which may be subtracted from the microphone 201 signal ((yₙ(t)), producing an error signal (eₙ(t)), wherein the error signal may be utilized to update the adaptive filter, as denoted by the dotted line illustrated in FIG. 3. This error signal may be utilized for the adaptive estimate of the acoustic feedback 402 path and computed as eₙ(t)=yₙ(t)−(dₙ(t)). Further the speaker signal (e.g., audio signal received at the speaker 225) may be equal to the error signal processed by the feedforward path (g(t)), resulting in an speaker signal (e.g., x(t)), wherein the feedforward path (e.g., feedforward path 220) may include any form of processing necessary for the audio pathway associated with the audio device. It may be seen that the estimate of the feedback path may include a bias which depends on the correlation between the speaker 225 and incoming audio signals received via one or more microphones 201, allowing for the incoming signal to behave or cause a disturbance, distortion, or the like to the acoustic feedback cancellation system 400.

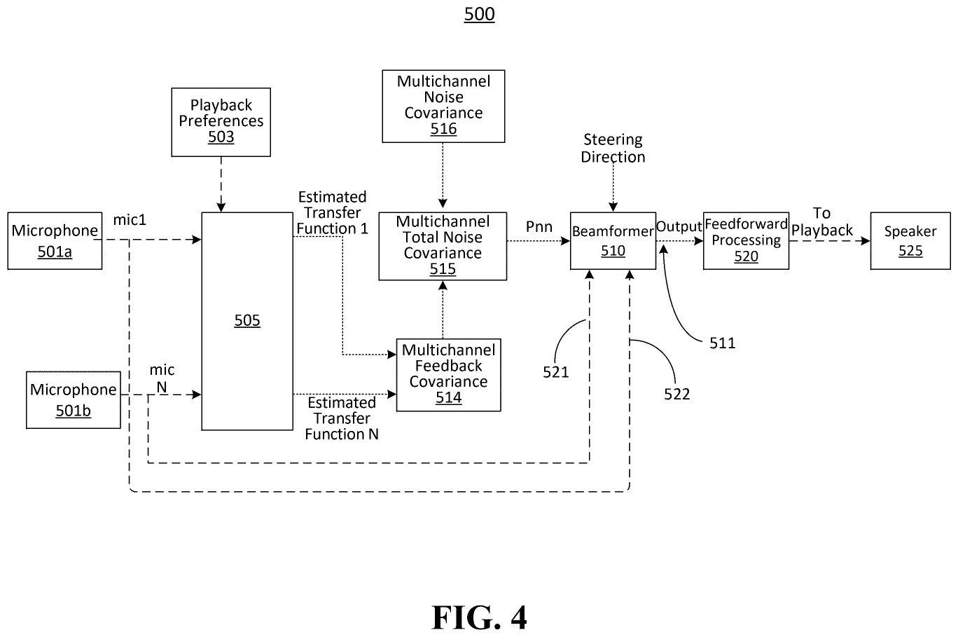

FIG. 4 illustrates a block diagram of an example data pipeline associated with an acoustic feedback cancellation mitigation process, in accordance with an example of the present disclosure. It is contemplated that a processor of an electronic device or an audio device associated with audio signaling processing may be configured or utilized to perform the functions of FIG. 4. It is contemplated that the functions of data pipeline 500 may occur on a chip or processor designed to support audio pathways in a device, such that audio signals may be decoded, amplified, or the like. Data pipeline 500 may include one or more microphones (e.g., microphones 501a,501b), multichannel neural network 505 (e.g., one or more acoustic feedback cancellers or more generally transfer function estimation components), a beamformer (BF) 510, a multichannel feedback covariance block 514, a multichannel total noise covariance block 515, a multichannel noise covariance block 516, feedforward processing block 520, or a speaker 525.

Microphones 501a,b may convert a sound to an audio signal. The sound may comprise an acoustic feedback and an input audio signal. The audio signal received via microphones 501a,b (e.g., raw or minimally manipulated microphone signals) may be transmitted to a BF 510 and to multichannel neural network 505. It is contemplated that there may be any number of microphones corresponding to multichannel neural network 505, for example there may be ‘N’ number of microphones. Multichannel neural network 505 may be configured to estimate transfer functions associated with each of the received audio signals, via one or more microphones. Multichannel neural network 505 may include an adaptive filter that may be utilized to estimate a transfer function. The transfer function may be a representation of a comparison of multiple audio signals (e.g., the input to microphones 501a,b and the output from the speaker 525—playback reference 503) to verify proper gain, phase, or frequency response through a device. The output from speaker 525 may be considered a playback reference 503. Playback references in acoustic feedback cancellation may include signals representing the audio emitted by a speaker that could re-enter a microphone and cause feedback. These references can include the direct speaker output signals, filtered playback signals reflecting the acoustic path, outputs from adaptive filters estimating the feedback signal, delayed playback signals accounting for propagation delay, and residual signals representing the difference between the microphone input and the estimated feedback. Such references are used to model, predict, and cancel the feedback signal, ensuring effective acoustic feedback mitigation.

Multichannel neural network 505 may generally be considered associated with a neural network-based or the like implementation for processing multiple channels. The multichannel transfer function estimation may be implemented using various neural network architectures. For example, the neural network may comprise a parallel network architecture where each channel is processed independently, a convolutional neural network architecture that processes spatial relationships across channels, a long short-term memory (LSTM) network that captures temporal dependencies in the signal, a transformer network that uses self-attention mechanisms to model relationships between channels, or a hybrid architecture combining convolutional and recurrent neural network layers. Each architecture may be configured to receive the multichannel input signals and playback references to estimate the transfer functions between the speakers and microphones. It is contemplated that other structures that perform the functions of multichannel neural network 505 (e.g., performs transfer function estimation) may be substituted for multichannel neural network 505.

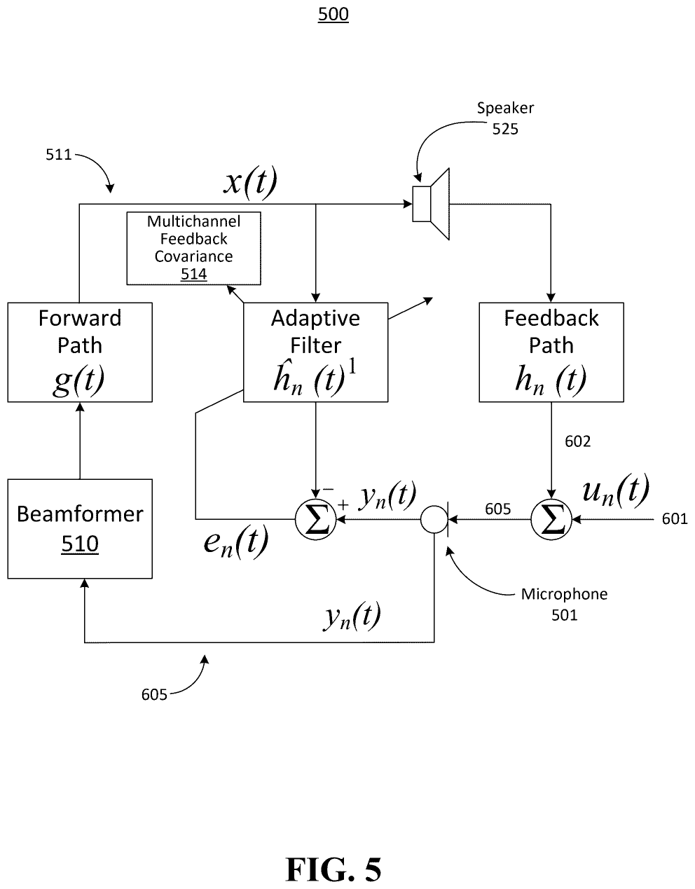

Multichannel neural network 505 may output one or more transfer functions associated with multichannel neural network 505 to multichannel feedback covariance block 514. The transfer functions may be combined, such as with a matrix. The combined transfer functions of the multichannel feedback covariance block 514 may be further combined with the multichannel noise covariance of block 516. The combination of multichannel feedback covariance of block 514 and the multichannel noise covariance of block 516 may constitute a multichannel total noise covariance of block 515. The multichannel total noise covariance block 515 may be a function that represents the noise associated with the received audio signals via microphone 501a,b. The resultant association of multichannel total noise covariance block 515 may be utilized by BF 510. BF 510 may also receive audio signals directly from microphones 501a,b. The combination of the multichannel total noise covariance of block 515 and audio signals 521,522 associated with microphones 501a,b, may be received and analyzed by BF 510. BF 510 may enhance the audio signals 521,522 received via microphones 501a,b in a determined steering direction. The use of transfer functions and filtering of the received audio signals 521,522 by BF 510 may allow for more precise and spatially directed acoustic feedback cancellation as the transfer functions may be utilized together. The output of BF 510 may be a target audio 511. The pathways associated with multichannel neural network 505 may be further illustrated in FIG. 5. With reference to FIG. 1, in some systems each audio signal received may experience filtering based on an estimated transfer function determined via acoustic feedback cancellers 205a,b before being sent to BF 210, in which BF 210 may only combine the outputs of acoustic feedback cancellers 205a,b. It is contemplated herein that the data pipeline 500 may include any amount of components as illustrated, for example, there may be ‘N’ number of microphones (e.g., microphone 501a,b) corresponding to ‘N’ multichannel neural network 505, there may also be one or more speakers 525 associated with the data pipeline 500.

FIG. 5 illustrates an example block diagram of adaptive feedback mitigation (AFM), in accordance with an example of the present disclosure. The AFM system 500 may receive an input (e.g., an audio signal) via microphones 501 (e.g., microphones 501a,b). The microphone 501 may include one audio signals (e.g., inputs yₙ(t)),), which may include an incoming audio signal 601 (uₙ(t)) and acoustic feedback 602 (hₙ(t)). As shown there may be coupling between the speaker 525 and the microphone 501 signals, wherein t is a function of time. The incoming audio signal 605 may be sent to BF 510. The acoustic feedback 602 may be estimated by using an adaptive filter (ĥₙ(t)), wherein the adaptive filter may include processes for estimating a transfer function. The estimated transfer functions may be summed and produce (eₙ(t)), in which eₙ(t) may be sent to the adaptive filter to update the estimate of ĥₙ(t). The transfer functions (e.g., ĥₙ(t)) may be sent to a multichannel feedback covariance 514 to aid in determining a target audio, wherein the transfer functions may estimate the acoustic feedback. Further the speaker signal (e.g., audio signal received at the speaker) may be equal to the one or more audio signals 605, sent to BF 510. The output of BF 510 may be sequentially processed by the feedforward path (g(t)) (e.g., feedforward processing 520), resulting in the target audio 511 (e.g., x(t)). The feedforward path 520 may include any form of processing for the audio pathway associated with the audio device. In the example of FIG. 5, AFM system 500 may filter one or more audio signals via BF 510. Filtering via BF 510 may allow for a more diverse and susceptible noise cancellation process as the transfer functions may be a function of the total audio signals received. BF 510 may be configured to take one or more audio signals captured by multiple sensors (e.g., microphones 501a,b) placed at different locations to leverage distinct spatial information associated with one or more audio signals arising from the difference in a microphones' placement to enhance the signal coming through the audio pathway associated with the target source location (e.g., target audio). This may be achieved by labeling the path from the target source location (e.g., target audio) associated with an audio signal and the other paths associated with non-target locations separately. Paths labeled as non-target locations may then be determined to be noise, wherein the beamformer 510 may cancel sounds coming through such non-target paths, while enabling the audio signals associated with the target audio 511 to pass through the BF 510. In some examples, the labeling paths of non-target locations as noise may be equivalent to transfer functions associated with such paths of non-target locations into the form of a multichannel covariance. Multichannel covariance (e.g., multichannel total noise covariance) may aid in BF 510 in determining audio signals associated with non-location targets or inform BF 510 which audio paths may need to be canceled, reduced, attacked, or the like, such that the target audio 511 is of a sufficient (e.g., within a predetermined threshold) gain, phase, frequency, amplification, or any other suitable method to enhance the sound associated with the target audio.

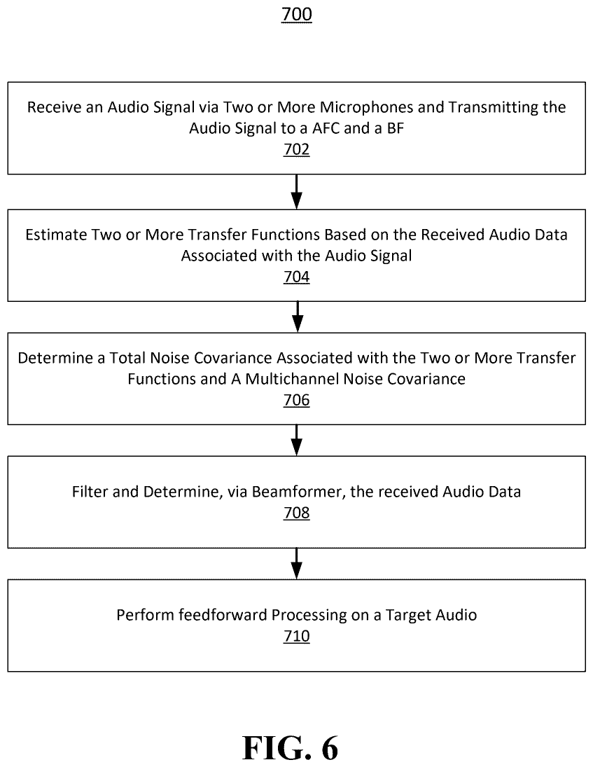

FIG. 6 is a method flow illustrating a method of adaptive feedback mitigation. A method 700 of adaptive feedback mitigation associated with audio data may include receiving audio data, via one or more microphone (e.g., microphone 501a, microphone 501b); estimating a transfer function via multichannel neural network 505, associated with the audio data; determining a multichannel total noise covariance (e.g., multichannel total noise covariance 515), which may correspond to a combination of a multichannel feedback covariance (e.g., multichannel feedback covariance 514) and a multichannel noise covariance (e.g., multichannel noise covariance 516), wherein the multichannel total noise covariance may comprise a number of transfer functions; filtering and determining a spatial directionality associated with the received audio data and transfer functions associated with the multichannel total noise covariance; and outputting a filtered and spatially directed audio data to feedforward processing.

At step 702, an audio device (e.g., smart glasses 100, headphones, hearing aids, or any device susceptible to acoustic feedback between a microphone and a speaker) may receive one or more audio data(s) via one or more microphones (e.g., microphone 501a), audio data may be sent, transferred, or transmitted to multichannel neural network 505 and a BF 510. Each of the one or more audio data associated with each of the one or more microphones may correspond to one or more multichannel neural networks 505. At step 704, smart glasses 100 may estimate one or more transfer functions, via multichannel neural network 505, based on the received audio data. Each of the one or more transfer functions may be a function based on the received audio data, wherein each of the one or more transfer functions may be associated with a noise associated with received audio data.

At step 706, smart glasses 100 may determine a total noise covariance (e.g., multichannel total noise covariance 515), which may correspond to a combination of a multichannel feedback covariance (e.g., multichannel feedback covariance 514) and a multichannel noise covariance (e.g., multichannel noise covariance 516). The multichannel feedback covariance 514 may include the one or more transfer functions estimated at step 704, wherein the one or more transfer functions may be organized or combined by any suitable method. At step 708, smart glasses 100 may filter, via a BF 510, the received audio data captured via step 702 based on the multichannel total noise covariance 515. Multichannel total noise covariance 515 may be based on multichannel feedback covariance 514 and multichannel noise covariance 516. The smart glasses 100 may also define a spatial directionality associated with the received audio data, via one or more transfer functions, wherein the one or more transfer functions may represent the path from the audio source (e.g., source of audio signal) to one or more microphones 501. The filtering and determination of the spatial directionality of the received audio data may define a target audio data, wherein the target audio data may be audio of interest to a user. At step 710, smart glasses 100 may perform feedforward processing 520 on the target audio 511 to transmit a sound associated with the target audio 511. Feedforward processing 520 may be a data function or process used to adjust the target data for presenting sound, via one or more speakers.

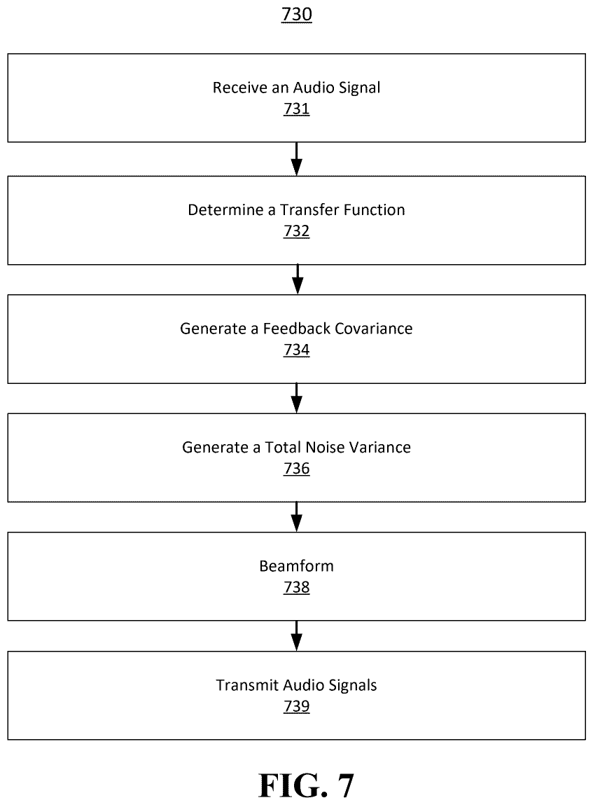

FIG. 7 illustrates an example method 730 for acoustic feedback mitigation through spatial processing. At step 731, audio signals from a microphone 501 may be received. The audio signals may be captured by one or more microphones 501 in devices such as smart glasses 100, hearing aids, headphones, or other audio devices where acoustic feedback between speakers and microphones can occur.

At step 732, a transfer function between a speaker 525 and the microphone 501 may be determined. The transfer function represents the acoustic path and characterizes how audio signals propagate between the speaker 525 and microphone 501. The transfer function determination may include estimating transfer functions without performing feedback signal subtraction in individual microphone channels, which may allow for more efficient processing compared to conventional per-channel subtraction approaches.

At step 734, a feedback covariance 514 may be generated using the determined transfer functions. The feedback covariance 514 may provide a representation of the spatial relationships and correlations in the acoustic feedback paths. The feedback covariance 514 may enable analysis of spatial properties of feedback paths across microphone channels to understand how acoustic feedback manifests in different spatial locations or orientations.

At step 736, a total noise variance 515 may be generated based on combining the feedback covariance 514 and a noise covariance 516. The noise covariance may account for ambient and system noise sources separate from acoustic feedback. This combination may provide a comprehensive model of noise and interference sources affecting the audio signals.

At step 738, beamforming 510 may be performed based on the total noise variance 515. The beamforming process may apply spatial filtering to suppress audio signals from feedback paths while preserving audio signals from target directions. This selective spatial filtering may help maintain desired audio quality while reducing unwanted acoustic feedback. The beamforming configuration may be adjusted based on determining a target direction for audio capture, allowing the system to focus on desired sound sources.

At step 739, audio signals based on the beamforming output (target audio 511) may be transmitted to speakers or other audio output devices. The beamforming process may include suppressing audio signals from non-target directions, including feedback paths, to produce cleaner audio output. The system may continuously monitor acoustic conditions and update the feedback covariance accordingly, allowing the beamforming to adapt to changing environments. This adaptive approach may help maintain optimal acoustic feedback mitigation as conditions change.

It is contemplated that the functions or steps herein may be performed in any suitable order, wherein each step may be performed simultaneously, stepwise or any suitable fashion for adaptive feedback mitigation. The functions or steps may occur on one device or distributed over multiple devices.

FIG. 8 illustrates a block diagram of an example hardware/software architecture of user equipment (UE) 30. The UE 30 (e.g., smart glasses 100, node 30, or the like) may include a processor 32, non-removable memory 44, removable memory 46, a speaker/microphone 38, a keypad 40, a display, touchpad, and/or indicators 42, a power source 48, a global positioning system (GPS) chipset 50, an inertial measurement unit (IMU) 56, and other peripherals 52. The UE 30 may also include a camera 54. In an example, the camera 54 is a smart camera configured to sense images appearing within one or more bounding boxes. The IMU 56 may be an electronic device that measures and reports specific force, angular rate, orientation of a device (e.g., UE 30) using a combination of accelerometers, gyroscopes, and in some instances magnetometers. The IMU 56 may also determine inertial movement of a device (e.g., UE 30). Additionally, the IMU 56 may be a sensor (e.g., a motion sensor) configured to determine changes in motion of a device (e.g., UE 30). The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals 21. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

FIG. 9 illustrates an example head mounted device (HMD) 100 (e.g., smart glasses 100) which may be associated with audio content or artificial reality content. Artificial reality (AR) is a form of reality that has been adjusted in some manner before presentation to a user, which may include, for example, a virtual reality, an augmented reality, a mixed reality, a hybrid reality, or some combination or derivative thereof. Artificial reality content may include completely computer-generated content or computer-generated content combined with captured (e.g., real-world) content. The artificial reality content may include video, audio, haptic feedback, or some combination thereof, any of which may be presented in a single channel or in multiple channels (such as stereo video that produces a three-dimensional (3D) effect to the viewer). Additionally, in some instances, artificial reality may be associated with applications, products, accessories, services, or some combination thereof, that may be used to, for example, create content in an artificial reality or are otherwise used in (e.g., to perform activities in) an artificial reality. HMD 100 may include frame 102 (e.g., an eyeglasses frame), a camera 104, a display 108, and an audio device 110 (which may include one or more speakers or microphones). Display 108 may be configured to direct images to a surface 106 (e.g., a user's eye or another structure). In some examples, HMD 100 may be implemented in the form of augmented-reality glasses. Accordingly, display 108 may be at least partially transparent to visible light to allow the user to view a real-world environment through the display 108. The audio device 110 may provide audio associated with augmented-reality content to users and capture audio signals.

Tracking of surface 106 may be beneficial for graphics rendering or user peripheral input. In many systems, HMD 100 design may include one or more cameras 104 (e.g., a front facing camera(s) away from a user or a rear facing camera(s) towards a user. Camera 104 may track movement (e.g., gaze) of eye of a user or line of sight associated with user. HMD 100 may include an eye tracking system to track the vergence movement of a user. Camera 104 may capture images or videos of an area, or capture video or images associated with surface 106 (e.g., eyes of a user or other areas of the face) depending on the directionality and view of camera 104. In examples where camera 104 is rear facing towards the user, camera 104 may capture images or videos associated with surface 106. In examples where camera 104 is front facing away from a primary user, camera 104 may capture images or videos of an area or environment. HMD 100 may be designed to have both front facing and rear facing cameras (e.g., camera 104). There may be multiple cameras 104 that may be used to detect the reflection off of surface 106 or other movements (e.g., glint or any other suitable characteristic). Camera 104 may be located on frame 102 in different positions. Camera 104 may be located along a width of a section of frame 102. In some other examples, the camera 104 may be arranged on one side of frame 102 (e.g., a side of frame 102 nearest to the eye). Alternatively, in some examples, the camera 104 may be located on display 108. In some examples, camera 104 may be sensors or a combination of cameras and sensors to track eye (e.g., surface 106) of a user.

Audio device 110 may be located on frame 102 in different positions or any other configuration such as but not limiting to headphone(s) communicatively connected to HMD 100, a peripheral device, or the like. Audio device 110 may be located along a width of a section of frame 102. In some other examples, the audio device may be arranged on sides of frame 102 (e.g., a side of frame 102 nearest to the car). In some examples, audio device 110 may be sensors or a combination of speakers, microphones, or other sensors to capture or produce sound associated with a user.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

Methods, systems, or apparatus with regard to audio feedback mitigation through spatial processing are disclosed herein. A method, system, or apparatus may provide for receiving audio signals from a plurality of microphones; estimating transfer functions between a speaker and the plurality of microphones; generating a feedback covariance matrix using the estimated transfer functions; combining the feedback covariance matrix with a noise covariance matrix; and performing beamforming using the combined covariance matrices to produce output audio. Estimating transfer functions may include operating acoustic feedback canceller components corresponding to the plurality of microphones and determining acoustic paths between the speaker and the plurality of microphones. The feedback covariance may be generated based on spatial relationships associated with audio signals. The method may include receiving raw microphone signals directly from the plurality of microphones and applying beamforming to the raw microphone signals using the combined covariance matrices. The method may determine spatial properties of feedback paths across microphone channels based on the feedback covariance matrix. Performing beamforming may include applying spatial filtering to suppress audio signals from feedback paths while preserving audio signals from target directions. The method may include generating a multichannel total covariance matrix by combining the feedback covariance matrix with the noise covariance matrix. Transfer functions may be determined (e.g., estimated) without performing feedback signal subtraction in individual microphone channels. The method may include determining a target direction for audio capture; configuring the beamforming based on the target direction; and suppressing audio signals from non-target directions including feedback paths. The feedback covariance matrix may be updated based on changes in acoustic conditions and the beamforming may be adjusted using the updated feedback covariance matrix. The method may include receiving the audio signals at different spatial locations; constructing the feedback covariance matrix to represent spatial relationships between the feedback paths; and applying the beamforming to leverage the spatial relationships for feedback suppression. All combinations (including the removal or addition of steps) in this paragraph and the above paragraphs are contemplated in a manner that is consistent with the other portions of the detailed description.

Methods, systems, or apparatuses with regard to audio signal processing are disclosed herein. In an example, a method may include receiving an audio signal via one or more microphones associated with a device, wherein the audio signal may be converted to audio data; transmitting the audio data to a beamformer and one or more transfer function estimation components; estimating one or more transfer functions via the one or more transfer function estimation components; determining a total noise covariance associated with a combination of the one or more transfer functions and a noise covariance; filtering the received audio data via a beamformer based on the total noise covariance to determine a target audio; enhancing a spatial direction associated with the target audio; and performing feedforward processes to adjust the target audio for transmission using a speaker of a device. The device may include smart glasses, headphones, hearing aids, laptops, conferencing systems, or any device susceptible to acoustic feedback between a microphone and a speaker. All combinations (including the removal or addition of steps) in this paragraph and the above paragraphs are contemplated in a manner that is consistent with the other portions of the detailed description.

What is claimed:

1. A method comprising:
receiving audio signals;
determining, based on the audio signals, a transfer function between a speaker and a microphone;
generating a feedback covariance using the transfer function;
generating a total noise variance based on a combination of the feedback covariance and a noise covariance; and
beamforming based on the total noise variance.

2. The method of claim 1, further comprising:
transmitting audio based on the beamforming.

3. The method of claim 1, wherein the beamforming is further based on microphone signals from the microphone.

4. The method of claim 1, further comprising:
determining spatial properties of feedback paths across microphone channels based on the feedback covariance.

5. The method of claim 1, wherein the beamforming comprises applying spatial filtering to suppress audio signals from feedback paths while preserving audio signals from target directions.

6. The method of claim 1, wherein the determining the transfer function comprises estimating the transfer function without performing feedback signal subtraction in individual microphone channels.

7. The method of claim 1, further comprising:
determining a target direction for audio capture; and
configuring the beamforming based on the target direction.

8. The method of claim 7, further comprising:
suppressing audio signals from non-target directions including feedback paths.

9. The method of claim 1, further comprising:
updating the feedback covariance based on changes in acoustic conditions; and
adjusting the beamforming using the updated feedback covariance.

10. A device comprising:
one or more processors; and
at least one memory storing instructions, that when executed by the one or more processors, cause the device to:
receive audio signals;
determine, based on the audio signals, a transfer function between a speaker and a microphone;
generate a feedback covariance using the transfer function;
generate a total noise variance based on a combination of the feedback covariance and a noise covariance; and
beamform based on the total noise variance.

11. The device of claim 10, wherein when the one or more processors further execute the instructions, the device is configured to:
transmit audio based on the beamform.

12. The device of claim 10, wherein the device comprises a head mounted device.

13. The device of claim 10, wherein when the one or more processors further execute the instructions, the device is configured to:
determine spatial properties of feedback paths across microphone channels based on the feedback covariance.

14. The device of claim 10, wherein when the one or more processors further execute the instructions, the device is configured to:
perform the beamform by applying spatial filtering to suppress audio signals from feedback paths while preserving audio signals from target directions.

15. The device of claim 10, wherein when the one or more processors further execute the instructions, the device is configured to:
perform the determine the transfer function by estimating transfer functions without performing feedback signal subtraction in individual microphone channels.

16. The device of claim 10, wherein when the one or more processors further execute the instructions, the device is configured to:
determine a target direction for audio capture; and
configure the beamform based on the target direction.

17. The device of claim 16, wherein when the one or more processors further execute the instructions, the device is configured to:
suppress audio signals from non-target directions including feedback paths.

18. The device of claim 10, wherein when the one or more processors further execute the instructions, the device is configured to:
update the feedback covariance based on changes in acoustic conditions; and
adjust the beamform using the updated feedback covariance.

19. A non-transitory computer-readable medium storing instructions that, when executed, cause:
receiving audio signals;
determining, based on the audio signals, a transfer function between a speaker and a microphone;
generating a feedback covariance using the transfer function;
generating a total noise variance based on a combination of the feedback covariance and a noise covariance; and
beamforming based on the total noise variance.

20. The non-transitory computer-readable medium of claim 19, wherein the instructions, when executed, further cause:
transmitting audio based on the beamform.
